(19) United States
(12) Patent Application Publication
(10) Pub. No.: US 2010/0063891 A1
(43) Pub. Date: Mar. 11, 2010

(54) RETAIL SHOPPING METHOD AND SYSTEM USING UPC CAPTURE

(75) Inventors: Karl A. Townsend, Los Altos, CA (US); Mark Bercow, Menlo Park, CA (US); David Vadasz, Los Altos, CA (US)

Correspondence Address: FOLEY & LARDNER LLP, 777 EAST WISCONSIN AVENUE, MILWAUKEE, WI, 53202-5306, US

(73) Assignee: Palm, Inc.

(21) Appl. No.: 12/239,476

(22) Filed: Sep. 26, 2008

Related U.S. Application Data
(60) Provisional application No. 61/096,235, filed on Sep. 11, 2008.

(51) Int. Cl. G06Q 30/00; G06Q 20/00; G01C 21/00

(52) U.S. Cl. 705/26; 701/300; 705/14.23

(57) ABSTRACT

A mobile computing device comprises a display, a sensor and processing circuit. The processing circuit is configured to receive first data associated with the product code from the sensor. The processing circuit is configured to search for a product associated with the product code and provide a list of merchants for the product. The list can be displayed on the display. The user can purchase the product from a first merchant on the list via an on-line payment or can receive an electronic indication of a discount from a second merchant on the list associated with a physical store.

### BACKGROUND

Mobile computing devices, such as mobile phones, smartphones, and personal digital assistants, can be used for various day-to-day applications. Mobile computing devices could be used to make the retail shopping experience easier and less expensive.

Heretofore, a customer in a retail shop (e.g., a brick and mortar retailer) may view a product that interests him or her, but the customer is hesitant to buy it because the customer does not have enough pricing information, quality information, customer reviews, product comparisons, etc. about the product. In these circumstances, the customer will not buy the product due to these uncertainties. If the customer discovers that the product price and quality were acceptable, he or she will have to re-visit the retail shop or otherwise make arrangements to purchase the product. In many circumstances, the customer is not able to adequately remember or record the exact model number for subsequent research and analysis.

A retailer would be desirous in relieving any uncertainties about a purchase for a customer in its retail shop. If the customer were to go to another retail shop based solely on pricing, the retailer may be interested in providing a lower price for that customer. Heretofore, the communications to relieve such uncertainty and to determine whether a buyer is about to purchase a product being motivated at a lower price required verbal communication between the retailer and the customer. In other situations, retailers are struggling to offer a value proposition to customers. If they invest in sales personnel that are qualified to provide information, they typically do not have a cost structure that allows them to offer a competitive price and they become a showroom while a low-cost competitor gets the sale.

### SUMMARY

An exemplary embodiment relates to a mobile computing device. The mobile computing device includes a display, a sensor, and a processing circuit. The processing circuit is configured to receive first data associated with a product code from the sensor. The processing circuit is configured to search for a product associated with the product code and provide a list of merchants for the product. The list is displayed on the display. A user can purchase the product from a first merchant on the list via an on-line payment or can receive an electronic indication of a discount from a second merchant on the list associated with a physical store or another on-line store.

Yet another exemplary embodiment relates to a method of purchasing a product using a mobile computing device. The method includes displaying a list of merchants and prices associated with the product. The list of merchants includes at least one on-line store and at least one physical store. The method also includes providing an on-line payment screen for the on-line store or providing an indication of a discount for a purchase in the physical store. The method also includes receiving a discount for the product in the physical store, and providing an on-line payment screen for the on-line store or providing an indication of the discount for the physical store or another on-line store.

Still another exemplary embodiment relates to a mobile computing device including a display and a processing circuit. The processing circuit is configured to provide an image to be displayed. The image includes an interface that allows the user to choose a first screen, a second screen and a third screen. The interface includes an identification of a product chosen by a user. The product is selected by the user via bar code, text recognition, etc. The first screen includes on-line purchase information for a product, the second screen includes pricing information from a plurality of merchants for the product, and a third screen includes review information for the product. Product comparison information may be provided on the second or third screen, or on a fourth screen.

### BRIEF DESCRIPTION OF THE DRAWINGS

FIGS. 1A through 1F illustrate a mobile computing device from various views, according to an exemplary embodiment;

FIG. 2 is a block diagram of the mobile computing device of FIGS. 1A through 1F, according to an exemplary embodiment;

FIG. 3 is a block diagram of the mobile computing device illustrated in FIGS. 1 and 2 being used in a shopping application in accordance with an exemplary embodiment;

FIG. 4 is a flow diagram showing processes for shopping using a mobile computing device, according to another exemplary embodiment; and

FIG. 5 is a block diagram of a screen shot for the processes illustrated in FIG. 4, according to an exemplary embodiment

### DETAILED DESCRIPTION OF THE EXEMPLARY EMBODIMENTS

Described herein are various exemplary embodiments of systems and methods for shopping (e.g., retail shopping) using a mobile computing device. Some embodiments may advantageously allow the user or customer to input a product identification using a sensor into the mobile computing device. The mobile computing device may further advantageously be configured to allow the user to view the product online or at other retailers. Some embodiments may allow online and other retailers to submit bids or prices for the products. A location sensor such as a GPS sensor or other location sensing technology such as described hereinbelow can be used in some embodiments to provide location which can be used by a processing circuit to provide lists of merchants having the product at nearby stores. Still another embodiment advantageously allows real time competition between retailers such that a retailer can identify a user that is interested in a purchasing in the store and can make a better offer or start a reverse auction. Yet other embodiments provide information to the customer so that the customer can confirm a product is in inventory at an online store or other store before seeking a purchase from those locations. Yet another embodiment allows the retailer to provide a coupon (e.g., received in a bar code format) for use when the product is purchased. Yet another embodiment provides a translator or parser that provides a universal UPC symbol from a retail UPC symbol. In one embodiment, the user captures an image of a UPC or other bar code and a mobile computing device provides additional information about the product.

Thus, embodiments described herein may use a mobile computing device to make the retail shopping experience easier. Embodiments described herein may use a mobile computing device to make the retail shopping experience less expensive to a customer. Embodiments described herein may use a mobile computing device to allow a retailer to make an offer to a customer based on price, delivery cost, availability, and/or other factors. Further still, embodiments described herein may provide more in-depth product information and comparisons, which may prompt a customer to proceed with a purchase without going home or to an additional store for additional research.

The embodiments described herein may allow a customer to quickly and securely search for a best possible price and availability of a product found in a retail store, while also offering the opportunity to compete for the product.

The teachings herein extend to those embodiments that fall within the scope of the appended claims, regardless of whether they accomplish one or more of the above-mentioned exemplary advantages.

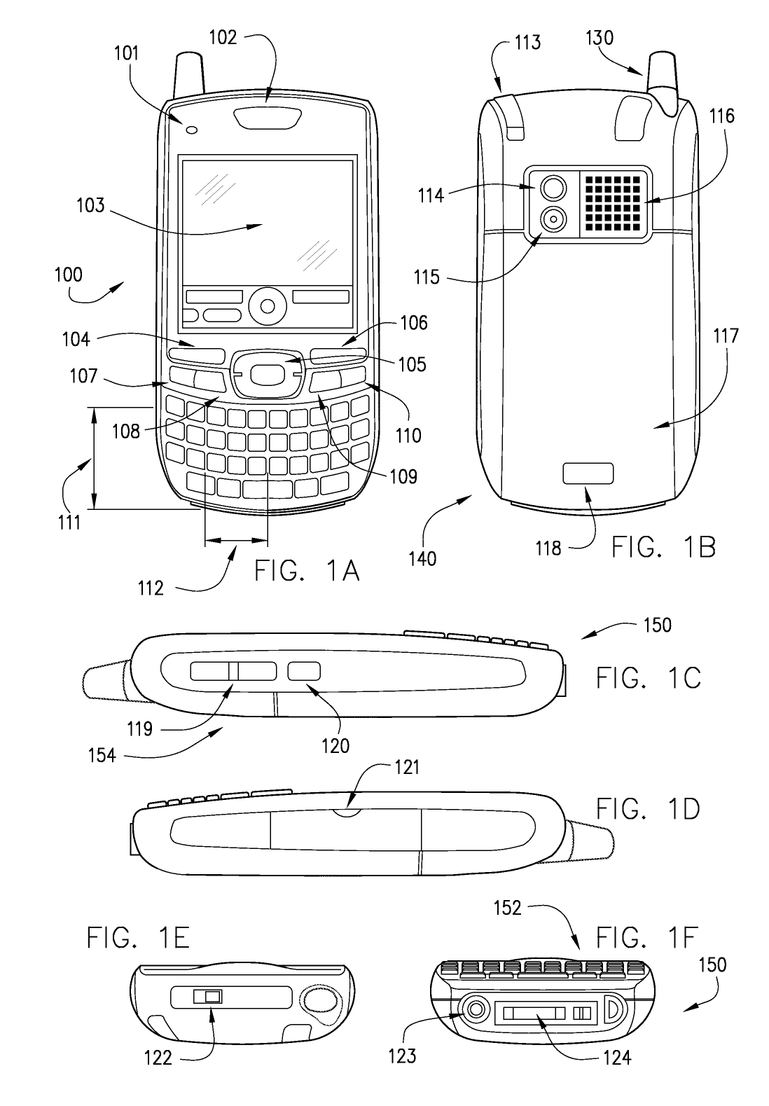

Referring to FIGS. 1A through 1F, a mobile computing device 100 is shown from various angles, according to an exemplary embodiment. FIG. 1A is a front view of device 100; FIG. 1B is a rear view of device 100; FIGS. 1C and 1D are side views of device 100; and FIGS. 1E and 1F are top and bottom views of device 100. The device may be any type of communications or computing device (e.g., a cellular phone, other mobile device, digital media player (e.g., audio or audio/video), personal digital assistant, etc.).

Device 100 may be a smart phone, which is a combination mobile telephone and handheld computer having personal digital assistant (“PDA”) functionality. The teachings herein can be applied to other mobile computing devices (e.g., a laptop computer) or other electronic devices (e.g., a desktop personal computer, etc.). PDA functionality can comprise one or more of personal information management, database functions, word processing, spreadsheets, voice memo recording, location-based services, device backup and lock, media playing, Internet browsing, etc. and is configured to synchronize, publish/subscribe, download, or otherwise communicate personal information or user data (e.g., contacts, e-mail, calendar, notes, to-do list, web browser favorites, etc.) from one or more applications with a computer (e.g., desktop, laptop, server, etc.). Device 100 is further configured to receive and operate additional applications provided to device 100 after manufacture, e.g., via wired or wireless download, Secure Digital card, etc.

Device 100 may be a handheld computer (e.g., a computer small enough to be carried in a typical front pocket found in a pair of pants, purse or other similar pocket), comprising such devices as typical mobile telephones and PDAs, but the term “handheld” and the phrase “configured to be held in a hand during use” excluding typical laptop computers and tablet personal computers (“PCs”) for purposes of this disclosure. In alternative embodiments, the teachings herein may extend to laptop computers, tablet PCs, desktop PCs, and other electronic devices. The various input devices and other parts of device 100 as described below may be positioned anywhere on device 100 (e.g., the front side of FIG. 1A, the rear side of FIG. 1B, the sides of FIGS. 1C and 1D, on a keyboard which is retractable to slide in and out from a portion of device 100 to be revealed along any of the sides of device 100, etc.).

Device 100 includes various user input devices. For example, the user input devices may include a send button 104 usable to select options appearing on display 103 and/or send messages, a 5-way navigator 105 usable to navigate through options appearing on display 103, a power/end button 106 usable to select options appearing on display 103 and to turn on display 103, a phone button 107 usable to access a phone application screen, a calendar button 108 usable to access a calendar application screen, a messaging button 109 usable to access a messaging application screen (e.g., e-mail, text, Multimedia Messaging Service (MMS), etc.), an applications button 110 usable to access a screen showing available applications, a thumb keyboard 111 (which includes a phone dial pad 112 usable to dial during a phone application), a volume button 119 usable to adjust the volume of audio output of device 100, a customizable button 120 which a user may customize to perform various functions, a ringer switch 122 usable to switch the device from one mode to another mode (such as switching from a normal ringer mode to a meeting ringer mode), and a touch screen display 103 usable to select control options displayed on display 103. Touch screen display 103 may comprise a capacitive touch screen, a mutual capacitance touch screen, a self capacitance touch screen, a resistive touch screen, a touch screen using cameras and light such as a surface multi-touch screen, proximity sensors, or other touch screen technologies. Touch screen display 103 may be configured to receive inputs from finger touches at a plurality of locations on display 103 at the same time. Touch screen display 103 may be configured to receive a finger swipe or other directional input, which may be interpreted by a processing circuit to control certain functions distinct from a single touch input.

Device 100 also includes various audio circuits. The audio circuits may include phone speaker 102 usable to listen to information in a normal phone mode, external speaker 116 louder than the phone speaker (e.g. for listening to music, for a speakerphone mode, etc.), headset jack 123 to which a user can attach an external headset which may include a speaker and/or a microphone, and a microphone that can be used to pick up audio information such as the user's end of a conversation during a phone call.

Device 100 may also include a status indicator 101 that can be used to indicate the status of device 100 (such as messages pending, charging, low battery, etc.), a stylus slot 113 for receiving a stylus usable to input data on touch screen display 103, a digital camera 115 usable to capture images, a mirror 114 positioned proximate camera 115 such that a user may view themselves in mirror 114 when taking a picture of themselves using camera 115, a removable battery 118, and a connector 124 which can be used to connect device 100 to either (or both) an external power supply such as a wall outlet or battery charger or an external device such as a personal computer, a global positioning system (“GPS”) unit, a display unit, or some other external device. Camera 115 can be used to capture product codes, (e.g., UPC bar codes). Alternatively, device 100 can include a scanner or bar code reader for capturing product codes.

Device 100 may also include an expansion slot 121 that may be used to receive a memory card and/or a device which communicates data through slot 121, and a Subscriber Identity Module (SIM) card slot 117, located behind battery 118, configured to receive a SIM card or other card that allows the user to access a cellular network.

In various embodiments device 100 may include a housing 140. Housing 140 may be configured to retain or secure a screen in a fixed relationship above a plurality of user input devices in a substantially parallel or same plane. A fixed relationship may exclude a hinged or movable relationship between the screen and plurality of keys in the fixed embodiment, though hinged or movable relationships may be used in other embodiments.

Housing 140 could be any size, shape, and dimension. In some embodiments, housing 140 has a width 152 (shorter dimension) of no more than about 200 mm or no more than about 100 mm. According to some of these embodiments, housing 140 has a width 152 of no more than about 85 mm or no more than about 65 mm. According to some embodiments, housing 140 has a width 152 of at least about 30 mm or at least about 50 mm. According to some of these embodiments, housing 140 has a width 152 of at least about 55 mm.

In some embodiments, housing 140 has a length 154 (longer dimension) of no more than about 200 mm or no more than about 150 mm. According to some of these embodiments, housing 140 has a length 154 of no more than about 135 mm or no more than about 125 mm. According to some embodiments, housing 140 has a length 154 of at least about 70 mm or at least about 100 mm. According to some of these embodiments, housing 140 has a length 154 of at least about 110 mm.

In some embodiments, housing 140 has a thickness 150 (smallest dimension) of no more than about 150 mm or no more than about 50 mm. According to some of these embodiments, housing 140 has a thickness 150 of no more than about 30 mm or no more than about 25 mm. According to some embodiments, housing 140 has a thickness 150 of at least about 10 mm or at least about 15 mm. According to some of these embodiments, housing 140 has a thickness 150 of at least about 50 mm. According to some embodiments, housing 140 has a thickness 150 of 11 mm or less.

In some embodiments, housing 140 has a volume of up to about 2500 cubic centimeters and/or up to about 1500 cubic centimeters. In some of these embodiments, housing 140 has a volume of up to about 1000 cubic centimeters and/or up to about 600 cubic centimeters.

Device 100 may include an antenna 130 system for transmitting and/or receiving radio frequency signals. Each transceiver of device 100 may include individual antennas or may include a common antenna 130. The antenna system may include or be implemented as one or more internal antennas and/or external antennas.

While described with regards to a handheld device, many embodiments are usable with portable devices which are not handheld and/or with non-portable devices/systems.

Device 100 may provide voice communications functionality in accordance with different types of cellular radiotelephone systems. Examples of cellular radiotelephone systems may include Code Division Multiple Access (“CDMA”) cellular radiotelephone communication systems, Global System for Mobile Communications (“GSM”) cellular radiotelephone systems, etc.

In addition to voice communications functionality, device 100 may be configured to provide data communications functionality in accordance with different types of cellular radiotelephone systems. Examples of cellular radiotelephone systems offering data communications services may include GSM with General Packet Radio Service (“GPRS”) systems (“GSM/GPRS”), CDMA/1xRTT (1 times Radio Transmission Technology) systems, Enhanced Data Rates for Global Evolution (“EDGE”) systems, Evolution Data Only or Evolution Data Optimized (“EV-DO”) systems, etc.

Device 100 may be configured to provide voice and/or data communications functionality through wireless access points (“WAPs”) in accordance with different types of wireless network systems. A wireless access point may comprise any one or more components of a wireless site used by device 100 to create a wireless network system that connects to a wired infrastructure, such as a wireless transceiver, cell tower, base station, router, cables, servers, or other components depending on the system architecture. Examples of wireless network systems may further include a wireless local area network (“WLAN”) system, wireless metropolitan area network (“WMAN”) system, wireless wide area network (“WWAN”) system (e.g., a cellular network), and so forth. Examples of suitable wireless network systems offering data communication services may include the Institute of Electrical and Electronics Engineers (“IEEE”) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, a wireless personal area network (“PAN”) system, such as a Bluetooth® system operating in accordance with the Bluetooth Special Interest Group (“SIG”) series of protocols.

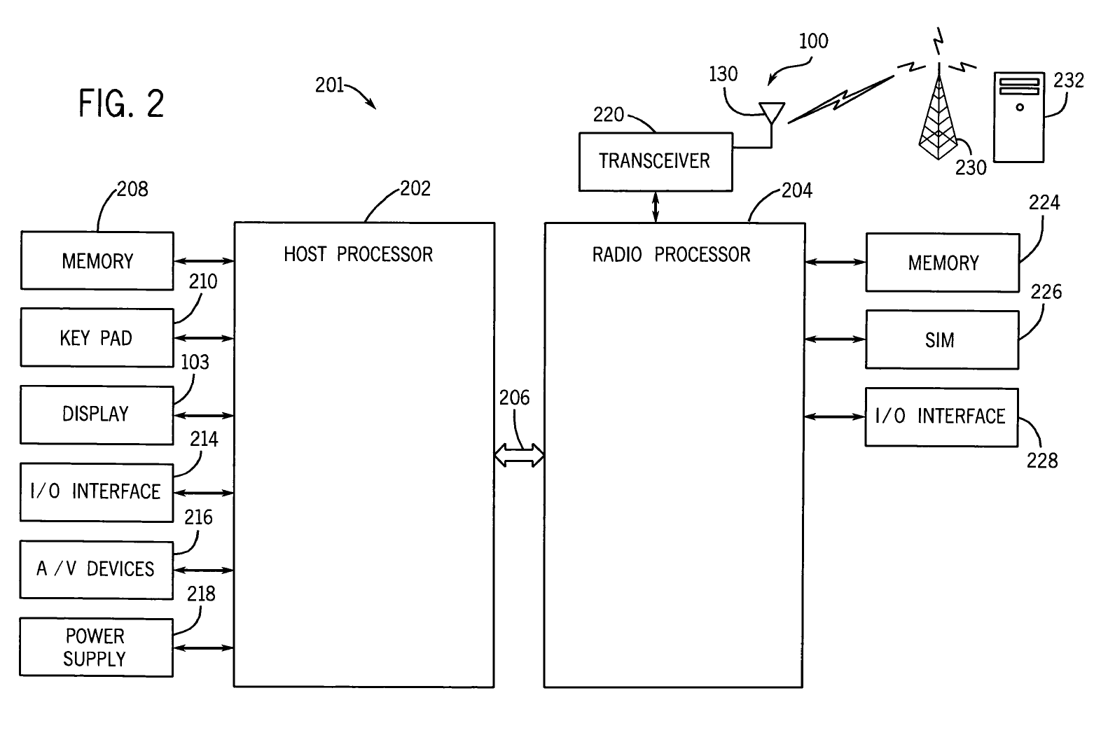

As shown in the embodiment of FIG. 2, device 100 comprises a processing circuit 201, which may comprise a dual processor architecture, including a host processor 202 and a radio processor 204 (e.g., a base band processor or modem). Host processor 202 and radio processor 204 may be configured to communicate with each other using an interface 206 such as one or more universal serial bus (“USB”) interfaces, micro-USB interfaces, universal asynchronous receiver-transmitter (“UART”) interfaces, general purpose input/output (“GPIO”) interfaces, control/status lines, control/data lines, shared memory, and so forth.

Host processor 202 may be configured to execute various computer programs (e.g., software, firmware, or other code) such as application programs and system programs to provide computing and processing operations for device 100. Radio processor 204 may be responsible for performing various voice and data communications operations for device 100 such as transmitting and receiving voice and data information over one or more wireless communications channels. Although embodiments of the dual processor architecture may be described as comprising host processor 202 and radio processor 204 for purposes of illustration, the dual processor architecture of device 100 may comprise one processor, more than two processors, may be implemented as a dual- or multi-core chip with both host processor 202 and radio processor 204 on a single chip, etc. Alternatively, a single processor or multiple processors may perform the functions of host processor 202 and radio processor 204, such as a single, unified processor that handles host and radio functions, or other multiprocessor topologies which do not rely on the concept of a host. Alternatively, processing circuit 201 may comprise any digital and/or analog circuit elements, comprising discrete and/or solid state components, suitable for use with the embodiments disclosed herein.

In various embodiments, host processor 202 may be implemented as a host central processing unit (“CPU”) using any suitable processor or logic device, such as a general purpose processor. Host processor 202 may comprise, or be implemented as, a chip multiprocessor (“CMP”), dedicated processor, embedded processor, media processor, input/output (“I/O”) processor, co-processor, field programmable gate array (“FPGA”), programmable logic device (“PLD”), or other processing device in alternative embodiments.

Host processor 202 may be configured to provide processing or computing resources to device 100. For example, host processor 202 may be responsible for executing various computer programs such as application programs and system programs to provide computing and processing operations for device 100. Examples of application programs may include, for example, a telephone application, voicemail application, e-mail application, instant message (“IM”) application, short message service (“SMS”) application, multimedia message service (“MMS”) application, web browser application, personal information manager (“PIM”) application (e.g., contact management application, calendar application, scheduling application, task management application, web site favorites or bookmarks, notes application, etc.), word processing application, spreadsheet application, database application, video player application, audio player application, multimedia player application, digital camera application, video camera application, media management application, a gaming application, and so forth. The application software may provide a graphical user interface (“GUI”) to communicate information between device 100 and a user. The computer programs may be stored as firmware on a memory associated with processor 202, may be loaded by a manufacturer during a process of manufacturing device 100, and may be updated from time to time with new versions or software updates via wired or wireless communication.

System programs assist in the running of a computer system. System programs may be directly responsible for controlling, integrating, and managing the individual hardware components of the computer system. Examples of system programs may include, for example, an operating system (“OS”), a kernel, device drivers, programming tools, utility programs, software libraries, an application programming interface (“API”), a GUI, and so forth. Device 100 may utilize any suitable OS in accordance with the described embodiments such as a Palm OS®, Palm OS® Cobalt, Microsoft Windows® OS, Microsoft Windows® CE, Microsoft Pocket PC, Microsoft Mobile, Symbian OS™, Embedix OS, any Linux distribution, Binary Run-time Environment for Wireless (“BREW”) OS, JavaOS, a Wireless Application Protocol (“WAP”) OS, and so forth.

Device 100 may comprise a memory 208 coupled to host processor 202. In various embodiments, memory 208 may be configured to store one or more computer programs to be executed by host processor 202. Memory 208 may be implemented using any machine-readable or computer-readable media capable of storing data such as volatile memory or non-volatile memory, removable or non-removable memory, erasable or non-erasable memory, writeable or re-writeable memory, and so forth. Examples of machine-readable storage media may include, without limitation, random-access memory (“RAM”), dynamic RAM (“DRAM”), Double-Data-Rate DRAM (“DDRAM”), synchronous DRAM (“SDRAM)”, static RAM (“SRAM”), read-only memory (“ROM”), programmable ROM (“PROM”), erasable programmable ROM (“EPROM”), electrically erasable programmable ROM (“EEPROM”), flash memory (e.g., NOR or NAND flash memory), or any other type of media suitable for storing information.

Although memory 208 is shown as being separate from host processor 202 for purposes of illustration, in various embodiments some portion or the entire memory 208 may be included on the same integrated circuit as host processor 202. Alternatively, some portion or the entire memory 208 may be disposed on an integrated circuit or other medium (e.g., hard disk drive) external to the integrated circuit of host processor 202. In various embodiments, device 100 may comprise a memory port or expansion slot 121 (shown in FIG. 1) to support a multimedia and/or memory card, for example. Processing circuit 201 may use memory port or expansion slot 121 to read and/or write to a removable memory card having memory, for example, to determine whether a memory card is present in port or slot 121, to determine an amount of available memory on the memory card, to store subscribed content or other data or files on the memory card, etc.

Device 100 may comprise a user input device 210 coupled to the host processor 202. User input device 210 may comprise, for example, a alphanumeric, numeric or QWERTY key layout and an integrated number dial pad. Device 100 also may comprise various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, a keypad and so forth. Examples of such objects are shown in FIG. 1 as 5-way navigator 105, power/end button 106, phone button 107, calendar button 108, messaging button 109, applications button 110, thumb keyboard 111, volume button 119, customizable button 120, and ringer switch 122.

The host processor 202 may be coupled to display 103. Display 103 may comprise any suitable visual interface for displaying content to a user of device 100. For example, display 103 may be implemented by a liquid crystal display (“LCD”) such as a touch-sensitive color (e.g., 16-bit color) thin-film transistor (“TFT”) LCD screen. In some embodiments, the touch-sensitive LCD may be used with a stylus and/or a handwriting recognizer program.

Device 100 may comprise an I/O interface 214 coupled to the host processor 202. I/O interface 214 may comprise one or more I/O devices such as a serial connection port, an infrared port, integrated Bluetooth® wireless capability, and/or integrated 802.11x (WiFi) wireless capability, to enable wired (e.g., USB cable) and/or wireless connection to a local computer system, such as a PC, or a remote computer system, such as a computer server. In various implementations, device 100 may be configured to transfer and/or synchronize information with the local computer system, such as personal information management data stored in one or more databases in memory 208.

Host processor 202 may be coupled to various audio/video (“A/V”) devices 216 that support A/V capability of device 100. Examples of A/V devices 216 may include, for example, a microphone, one or more speakers, an audio port to connect an audio headset, an audio coder/decoder (codec), an audio player, a digital camera, a video camera, a video codec, a video player, and so forth.

Host processor 202 may be coupled to a power supply 218 configured to supply and manage power to the elements of device 100. In various exemplary embodiments, power supply 218 may be implemented by a rechargeable battery, such as a removable and rechargeable lithium ion battery to provide direct current (“DC”) power, and/or an alternating current (“AC”) adapter to draw power from a standard AC main power supply.

As mentioned above, radio processor 204 may perform voice and/or data communication operations for device 100. For example, radio processor 204 may be configured to communicate voice information and/or data information over one or more assigned frequency bands of a wireless communication channel. Radio processor 204 may be implemented as a communications processor using any suitable processor or logic device, such as a modem processor or baseband processor. Radio processor 204 may comprise, or be implemented as, a digital signal processor (“DSP”), a media access control (“MAC”) processor, or any other type of communications processor in accordance with the described embodiments. Radio processor 204 may be any of a plurality of modems manufactured by Qualcomm, Inc. or other manufacturers.

Device 100 may comprise a transceiver 220 coupled to radio processor 204. Transceiver 220 may comprise one or more transceivers configured to communicate using different types of protocols, communication ranges, operating power requirements, RF sub-bands, information types (e.g., voice or data), use scenarios, applications, and so forth. For example, transceiver 220 may comprise a Wi-Fi transceiver and a cellular or WAN transceiver configured to operate simultaneously.

Transceiver 220 may be implemented using one or more chips as desired for a given implementation. Although transceiver 220 is shown as being separate from and external to radio processor 204 for purposes of illustration, in various embodiments some portion or the entire transceiver 220 may be included on the same integrated circuit as radio processor 204.

Device 100 may comprise an antenna or antenna system 130 for transmitting and/or receiving electrical signals. As shown, antenna system 130 may be coupled to radio processor 204 through transceiver 220. Radio tower 230 and server 232 are shown as examples of potential objects configured to receive a signal from antenna system 130.

Device 100 may comprise a memory 224 coupled to radio processor 204. Memory 224 may be implemented using any type of memory described with reference to memory 208. Although memory 224 is shown as being separate from and external to radio processor 204 for purposes of illustration, in various embodiments some portion or the entire memory 224 may be included on the same integrated circuit as radio processor 204. Further, host processor 202 and radio processor 204 may share a single memory.

Device 100 may comprise a SIM 226 coupled to radio processor 204. SIM 226 may comprise, for example, a removable or non-removable smart card configured to encrypt voice and data transmissions and to store user-specific data for allowing a voice or data communications network to identify and authenticate the user. SIM 126 also may store data such as personal settings specific to the user.

Device 100 may comprise an I/O interface 228 coupled to the radio processor 204. I/O interface 228 may comprise one or more I/O devices to enable wired (e.g., serial, cable, etc.) and/or wireless (e.g., WiFi, short range, etc.) communication between device 100 and one or more external computer systems.

In various embodiments, device 100 may comprise location or position determination capabilities. Device 100 may employ one or more position determination techniques including, for example, GPS techniques, Cell Global Identity (“CGI”) techniques, CGI including timing advance (“TA”) techniques, Enhanced Forward Link Trilateration (“EFLT”) techniques, Time Difference of Arrival (“TDOA”) techniques, Angle of Arrival (“AOA”) techniques, Advanced Forward Link Trilateration (“AFTL”) techniques, Observed Time Difference of Arrival (“OTDOA”), Enhanced Observed Time Difference (“EOTD”) techniques, Assisted GPS (“AGPS”) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), etc. Position determination techniques may be based on signals from one or more nearby cellular towers, one or more Wi-Fi access points (in which position is determined at least in part by collecting addresses of nearby wireless access points and comparing the addresses to a pre-stored database which associates addresses to geographic position), or other techniques.

In various embodiments, device 100 may comprise dedicated hardware circuits or structures, or a combination of dedicated hardware and associated software, to support position determination. For example, transceiver 220 and antenna system 130 may comprise GPS receiver or transceiver hardware and one or more associated antennas coupled to radio processor 204 to support position determination.

Host processor 202 may comprise and/or implement at least one location-based service (“LBS”) application. In general, the LBS application may comprise any type of client application executed by host processor 202, such as a GPS application configured to communicate position requests (e.g., requests for position fixes) and position responses. Examples of LBS applications include, without limitation, wireless 911 emergency services, roadside assistance, asset tracking, fleet management, friends and family locator services, dating services, and navigation services which may provide the user with maps, directions, routing, traffic updates, mass transit schedules, information regarding local points-of-interest (“POI”) such as restaurants, hotels, landmarks, and entertainment venues, and other types of LBS services in accordance with the described embodiments.

Radio processor 204 may be configured to generate a position fix by configuring a position engine and requesting a position fix. For example, a position engine interface on radio processor 204 may set configuration parameters that control the position determination process. Examples of configuration parameters may include, without limitation, location determination mode (e.g., standalone, Mobile Station-assisted, Mobile Station-based), actual or estimated number of position fixes (e.g., single position fix, series of position fixes, request position assist data without a position fix), time interval between position fixes, Quality of Service (“QoS”) values, optimization parameters (e.g., optimized for speed, accuracy, or payload), Position Determination Entity address (e.g., IP address and port number of LPS or MPC), etc. In one embodiment, the position engine may be implemented as a QUALCOMM® gpsOne® engine.

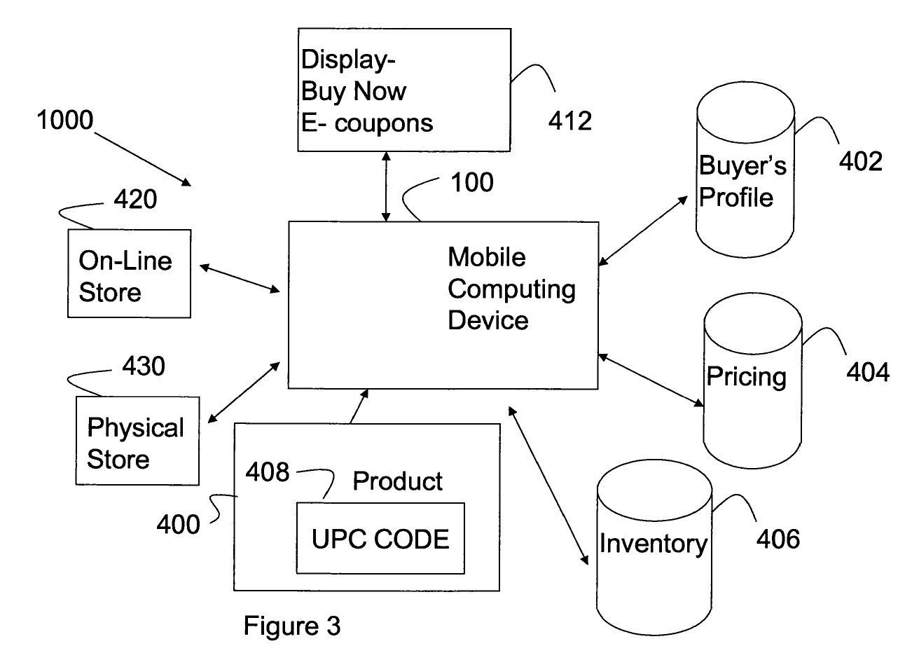

Referring to FIG. 3, mobile computing device 100 can be utilized in a retail environment to advantageously assist the retail shopping environment. According to one embodiment, a mobile computing customer has a mobile computing device 100, such as a TREO™ device and is shopping in a location in a store, such as a retail store. The customer could be in line at the store, waiting to purchase merchandise, browsing products, such as in a DVD section or DVD player section. The customer generally will desire to know that the price is appropriate for the items that they desire to purchase or may wish to know the content of product reviews about the product. The customer could use mobile computing device 100 to obtain customer reviews of a product such as product 400 and/or to capture a product code such as UPC code 408 associated with product 400. The product code can be captured according to a variety of techniques such as manually inputting a product code, scanning the product code with a bar code scanner or a camera, etc. In a preferred embodiment, computing device 100 includes a software routine for taking a picture of product code 408 and determining the product code. The picture can be taken via camera 115. Host processor 102 can operate the routine to determine the UPC number. Certain retail locations have UPC codes 408 that are unique to the retail location. Accordingly, post processor 102 can include a routine for translating the UPC code to a generic UPC code. Mobile computing device 100 can store such translations or tables for converting the UPC codes internally such as in memory or can access other servers such as through the internet for such information.

Mobile computer 100 preferably has remotely or internally stored buyers profile 402. Buyers profile 402 can include personal information such as addresses, shipping address and on-line payment information. In addition, buyers profile 402 can indicate the type of buyer the customer is and can include a history of previous payments and classifications of the buyer as a heavy user of a particular store or type of products. Such information may be useful by retailers either online or traditional brick and mortar retailers for determining what type of discounts the buyer may qualify for based on past purchases. Mobile computer 100 also includes remote or local storage of pricing information 404. Pricing information is preferably referenced to merchants who offer the product for sale. In addition, mobile computer 100 can have access to inventory information 406 which provides an indication of which merchants have inventory of product 400.

Mobile 100 can utilize its location or position determination capabilities to identify which merchant's store the customer is currently in and to identify merchants who are in close proximity. The list of merchants can be sorted by proximity or can be limited by proximity so that only merchants within a particular distance are listed. However, online merchants can be provided regardless of location.

The position and determination capabilities can utilize a GPS circuit or other position determination techniques. The use of location information allows the customer to determine whether a better deal might be available by simply walking across the street or whether paying slightly more for product 400 may be worth it in light of time and transportation expenses.

In this way, mobile computing device 100 communicates with online store 420 and physical store 430. Online store 420 and physical store 430 are illustrated in FIG. 3 as blocks, which may represent one or more computers, networks, or communication media located in-store, at a site remote from the store (even in a different country) which are operated by retail entities, wireless network carriers, and/or other third parties (e.g., under contract with a retail entity such as a dealer, salesman, etc.) in a manner that allows communication between retail entities associated with stores 420, 430 and device 100. Communication with online store 420 and physical store 430 allows a user to participate in a reverse-type auction or bidding for product 400. Physical store 430 can provide an electronic indication of the discount which can be embodied by a buy now e-coupon 412 provided on display 103. Alternatively, device 100 may communicate with an in-store kiosk or other terminal which provides a print out of the e-coupon. The e-coupon can include a UPC signal either in a paper coupon or on display 102, which can be scanned at the checkout. Alternatively, other ways of providing the discount can be provided. In addition, other server computers associated with physical stores can communicate with device 100 to provide a message stating, for example, that the customer can receive a particular discount on product 400 or discount on other products if the customer comes into the store within a set time period, or other messages, offers, or criteria. Such messaging can be arranged through the provider of cellular services to mobile computing device 100 or manufacturer of mobile computing device 100. A method for use with such a system may include payment to the mobile computing device manufacturer or to the provider of cellular services for such advertising or messaging to the customer. The buyer's profile information 402 can allow an online retailer to quote exact pricing with shipping. The buyer's profile may also include buying and shopping habits or history with the retailer and/or similar retailers, real-time credit rating, preferred shipping address, credit card number, etc. Therefore, an online merchant might give a potential buyer a price or other payment term based at least in part on one or more components of the buyer's profile.

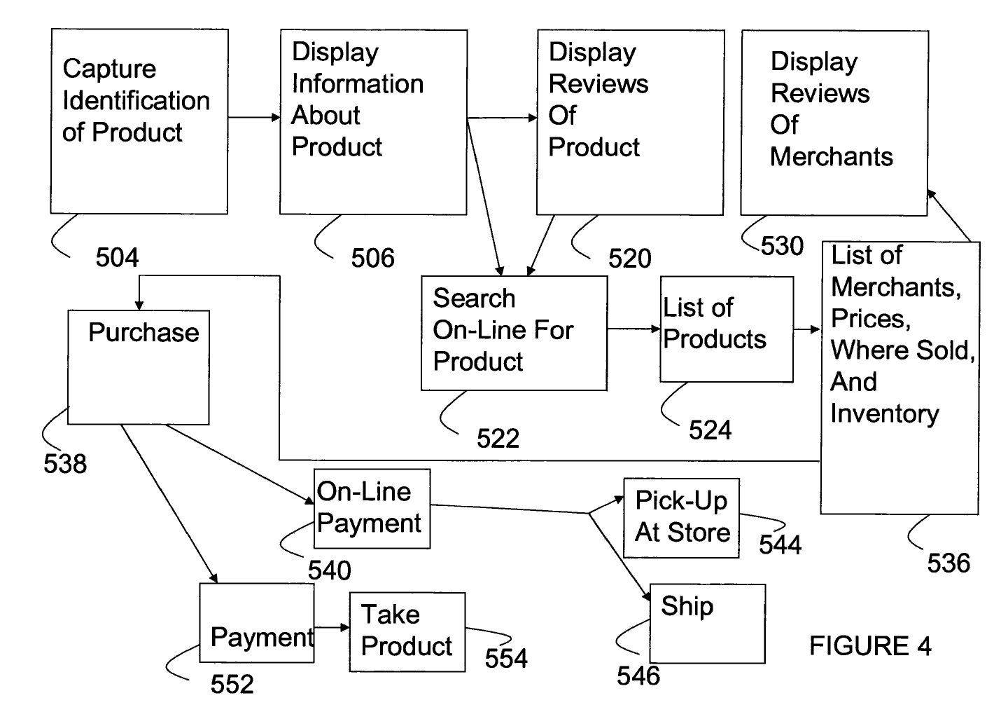

With reference to FIG. 4, mobile computing device 100 can be utilized in a process as follows: at a step 504, device 100 using camera 115 can capture an image of product 400 such as by capturing UPC code 408, receiving user input, other sensing techniques (e.g., radio frequency identifier technology), etc. At step 506 information about product 400 can be shown on display 102 of device 100. The information can include display of reviews of product at a step 520. If the reviews of the product may interest the customer making the purchase, customer can advance to step 522 and search online for product 400. Alternatively, after step 506, the customer can search online for product 400. At a step 524, the product as well as other products of similar interest can be provided. At a step 536, the list of merchants associated with the product, the prices, the locations of sale, and inventory can be shown at a step 536. Alternatively, step 536 can directly follow step 522. At a step 530, reviews of merchants can be viewed on display 102. At a step 538, the customer can determine to make a purchase either via online or through the physical store. If a purchase is elected through the physical store, the product is taken and brought to the checkout for conventional payment at step 552. At a step 554, the customer leaves with the product. At step 552, the customer can present an e-coupon as discussed with reference to FIG. 3 for a discount on the product. At a step 540, if the customer chooses to purchase the product via an online store or online retailer, the customer provides an online payment at step 40 (e.g., via PayPal, or credit card, etc.). At a step 544, the customer can elect to pick up product 400 at a particular physical location or store. Alternatively, the customer can have product 400 shipped to an address at a step 546.

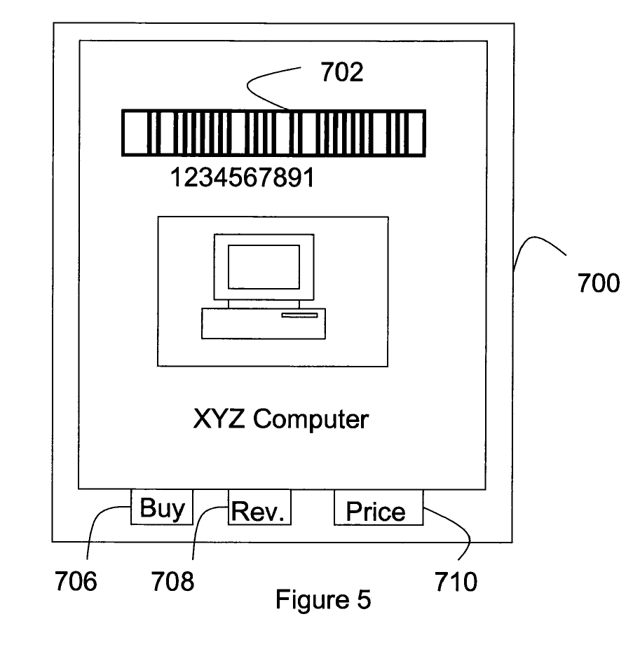

Referring to FIG. 5, a screen shot 700 for display on display 102 of device 100 is shown. Screen shot 700 shows a capture of a product code such as UPC symbol 702. Screen 100 may also include a picture of the product and a product name or short product description. Screen shot 700 can also include tabs 705, a tab 706 including an online purchase screen. A tab 708 can give the customer access to a review screen. The review screen can include reviews about product 400 as well as about merchants of product 400. A tab 710 can provide a pricing screen. The pricing screen can include prices associated with each merchant. The pricing can include discount offers currently being offered for the customer. The pricing screen may include an interface for entering a reverse auction application where retailers provide bids on lowest prices for product 400. Alternatively, other user interface means of accessing the various information associated with the retail transaction can be utilized. For example, icons, buttons, or other interfaces can be utilized to provide access to this instead of tabs 706, 708 and 710.

According to another embodiment, product comparison information may be provided on the pricing screen, the review information screen, or a fourth screen accessible similarly by a fourth tab (not shown). The product comparison information may provide information for a plurality of products of the same type or category as a product scanned by the user, which may be selected by the user or generated by the system based on a search of products of a similar type or category. A plurality of features of each product (e.g., price, customer reviews or ratings, reviews or ratings from critics or product evaluators, inventory status, specifications about the product, etc.) may be displayed as product comparison information.

Screen 700 may also include information about other purchases of the product and products that those purchasers also purchased. For example, a list of accessories may also be provided that may be desired for purchase with product 400.

Preferably, the retailer can confirm that the product is available in inventory before bidding. The access to online retailers not only provides significant advantages with respect to pricing, it also provides a convenience in areas where stores are crowded and a long wait in the checkout aisle is necessary. A user can avoid lines at the checkout aisle and simply make an online purchase and wait for a delivery. The reverse auction allows a retailer to “scoop” another retailer or otherwise obtain access to a customer who is not even at a store. In one embodiment, the UPC symbol may be typed in via a keyboard.

The process allows real time competition for customers' business in that once a customer sees a product, they have the ability to buy it anywhere, giving the customer encouragement to visit the store. Host processor 202 may utilize location-based service applications to determine the present location of the customer.

System 10 allows the blurring of online and physical purchasing as well as providing needed inventory and availability data. Host processor 202 preferably includes a routine for translating store specific UPC codes and redirecting to find store codes of preferred vendors both online and physical vendors.

In addition, screen 700 can include a tab for performing the scanning operation and a tab for submitting bids. The submission of bids can be performed through a website. In this embodiment, processor 202 can communicate via the internet to the website for performing bids. Retailers can provide a subscription fee or a per purchase fee for the ability to provide bids on the website. Alternatively, the bidding or auctioning by retailers can be provided by messaging processes. Messaging processes can include text messaging or email messaging.

The elements of data described above may each be stored in its own database, or may be grouped in any arrangement in one or more of databases created by device 100 and updated by device 100 from time to time as a user enters new data, downloads new applications, synchronizes with synchronization sources, configures new wireless configurations, etc.

The steps of FIG. 4 may be operable by one or more modules of a mobile computing device 100 or server computer or computers having one or more data files. Device 100 may be configured to store the data files in memory, for example as firmware.

The embodiments disclosed herein have been described with reference to block diagrams and flow diagrams. Each block may represent one or more computer programs (e.g., software, firmware, etc.) and/or the hardware or processing circuitry on which the computer programs operate (e.g., microprocessors, microcontrollers, application-specific integrated circuits, programmable logic, programmable gate array, etc.). Use of the term module herein may refer to either computer program and/or circuit components operating the computer program to carry out the functions described herein. Modules may interface with other modules at a hardware and/or computer program level, and may operate at and/or interface with other modules at any applicable computer program level specified in the Open Systems Interconnection (OSI) model, such as application layer, presentation layer, session layer, transport layer, network layer, data link, physical layer, etc. Modules may be represented by a block, multiple blocks or portions of blocks in the various figures herein.

According to one exemplary embodiment, device 100 can provide a message to a retail store when the customer has left or is leaving the store, which may be determined on device 100 by monitoring location data, or may be determined by a wireless receiver in the store (e.g., a wi-fi access point, Bluetooth receiver, infrared receiver, etc.) detecting that device 100 has left a range of wireless communication. In response to detecting the customer has left or is leaving, the retail store (such as physical store 430) may be configured to provide further information for an item the customer inquired about while in the store. For example, the further information may represent a coupon, discount, or other advertisement for a pricing offer for the item or related items. The further information can be used by physical store 430 to attract the customer back into the store. An on-line retailer or other merchant may also provide further information, such as a bid, price concession, coupon, or other offer to incentivize the customer to continue to leave the store and/or to purchase an item on-line or at another physical store. The reverse bidding process may be coordinated by or operated by a server computer in contact with device 100 and a plurality of merchants over a network, such as one or more of the Internet, a cellular network, a wi-fi network, etc. According to an alternative embodiment, an on-line store or other physical store located near the store can receive a message from device 100 and provide that the customer is in the store and provide bidding or other information to incentivize the customer to leave the store. Further, if the location indicates that the customer has left the store, an on-line store or other physical store can provide information about the product or pricing information or other bidding to incentivize the customer to view its website or enter its store. While the exemplary embodiments illustrated in the FIGS, and described above are presently exemplary, it should be understood that these embodiments are offered by way of example only. Accordingly, the present invention is not limited to a particular embodiment, but extends to various modifications that nevertheless fall within the scope of the appended claims.

What is claimed is:

1. A mobile computing device, comprising:
a display;
a sensor; and
a processing circuit configured to receive first data associated with a product code from the sensor, the processing circuit configured to search for a product associated with the product code and provide a list of merchants for the product, the list being displayed on the display, wherein a user can purchase the product from a first merchant on the list via an on-line payment or can receive an electronic indication of a discount from a second merchant on the list associated with a physical store.

2. The device of claim 1, wherein the sensor is a bar code reader.

3. The device of claim 1, wherein the sensor is a camera.

4. The device of claim 1, wherein the electronic indication is an E-coupon.

5. The device of claim 4, wherein the E-coupon includes a bar code provided on the display.

6. The device of claim 5, wherein the processing circuit is configured to communicate with a computer associated with the second merchant to receive the electronic indication of the discount

7. The device of claim 1, wherein the processing circuit provides inventory data with the list of merchants.

8. The device of claim 1, wherein the processing circuit is further configured to display reviews of the products.

9. The device of claim 1, wherein the processing circuit provides reviews of the merchants.

10. The device of claim 1, wherein the processing circuit is configured to communicate with a kiosk and the kiosk prints a coupon representing the electronic indication.

11. The device of claim 1, wherein the processing circuit is configured to determine a location associated with a user, wherein the list includes merchants within a particular distance from the location.

12. The device of claim 1, wherein the processing circuit is configured to determine a location associated with a user, wherein the list includes merchants sorted by distance from the location.

13. The device of claim 1, wherein the processing circuit provides a buyer profile to the first merchant or the second merchant.

14. A method of purchasing a product using a mobile computing device, the method comprising:
displaying a list of merchants and prices associated with a product, wherein the list of merchants includes at least one on-line store and at least one physical store; and
providing an on-line payment screen for the on-line store or providing an indication of a discount for a purchase in the physical store.

15. The method of claim 14, further comprising:
receiving a UPC code for the product.

16. The method of claim 14, wherein the displaying step also includes displaying inventory for the product.

17. The method of claim 14, further comprising:
determining a present location of the user, wherein the list includes merchants located near the present location.

18. A mobile computing device, comprising:
a display; and
a processing circuit configured to provide an image to the display, wherein the image includes an interface allowing the user to choose a first screen, a second screen, and a third screen, wherein the interface includes an identification of a product chosen by a user, the product is selected by the user via a bar code, the first screen including on-line purchase information for a product, a second screen including pricing information from a plurality of merchants for the product, and a third screen including review information for the product.

19. The mobile computing device of claim 18, wherein the bar code is provided to the processing circuit via a camera.

20. The mobile computing device of claim 18, further comprising: a location circuit, wherein the processing circuit provides a list of merchants having the product in accordance with location criteria using a location from the location circuit, the location being associated with a present location of a user.
